(19) United States
(12) Patent Application Publication
(10) Pub. No.: US 2015/0319262 A1
(43) Pub. Date: Nov. 5, 2015

(54) SIMULTANEOUS FORMATION OF ASSOCIATIONS AMONG MULTIPLE MEMBERS OF A SOCIAL NETWORK

(71) Applicant: Linkedln Corporation, Mountain View, CA (US)

(72) Inventors: Fei Xiao, San Jose, CA (US); Lifeng Sang, Sunnyvale, CA (US); Ting Chen, San Jose, CA (US)

(73) Assignee: Linkedln Corporation, Mountain View, CA (US)

(21) Appl. No.: 14/265,826

(22) Filed: Apr. 30, 2014

(51) Int. Cl. H04L 29/08; H04L 12/58

(52) U.S. Cl. CPC H04L 67/306; H04L 67/104; H04L 51/32

(57) ABSTRACT

A system, apparatus, and method are provided for facilitating simultaneous formation of associations or connections among multiple users of a professional network service, a social network service or other application or service in which users form relationships with each other. One user submits a request or suggestion to the system and identifies the multiple users (e.g., by username, by electronic mail address, by telephone number). The system dispatches invitations to some or all of the users to allow them to endorse connections with all of the other users, with none of the users, or with some specific subset. The system receives the responses and forms the approved associations.

### BACKGROUND

This disclosure relates to the field of computer systems. In particular, a system, apparatus, and methods are provided for facilitating simultaneous associations or connections among multiple members of a social network or other application or service.

Users of online applications are usually limited to connecting to one other user at a time. Generally, to make a connection, a user activates a control offered by the application specifically for that purpose. For example, a first user may search for a second user by name or, while using the application, may encounter information concerning the second user. Along with the second user's information, the application may offer a control that the first user can activate to dispatch a communication to the second user, asking him or her to form a connection. The second user may or may not accept the request.

Thus, the connection process generally requires the system to offer connection opportunities to a user, one at a time. As a result, a user can send but one request at a time, and each invitee receives and responds to only one request at a time. Therefore, fully connecting N users will require ½ (N×(N−1)) separate and independent requests to be offered, activated, and accepted.

### DESCRIPTION OF THE FIGURES

FIG. 1 is a block diagram depicting a system for supporting simultaneous creation of multiple user connections, in accordance with some embodiments.

FIG. 2 is a flow chart demonstrating a method of simultaneously forming connections or associations among multiple users of an application or service, in accordance with some embodiments.

FIG. 3 is an illustrative invitation sent to one of multiple users identified for simultaneous formation of connections or associations, in accordance with some embodiments.

FIG. 4 is a block diagram of an apparatus for simultaneously forming connections or associations among multiple users of an application or service, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the invention or inventions associated with this disclosure are not intended to be limited to the embodiments shown, but rather is to be accorded the widest scope consistent with the disclosure.

In some embodiments, a system, apparatus, and methods are provided for supporting simultaneous formation of associations or connections among multiple users of an application or service. These embodiments are described as they might be implemented with or within a professional network service or social network service, but they may be readily modified for use with another online application or service in which users form associations with each other.

In these embodiments, a user of the application or service submits a request for connections to be established between multiple users, which may or may not include the user who submitted the request. The system receives and processes the request, may verify the users' identities and/or screen the requester and/or the users to detect spammers and/or other undesirable actors, and then issues to each of the multiple users an invitation that allows the user to simultaneously approve connections with some or all of the other users. Based on the users' responses to their invitations, the system automatically forms the approved connections.

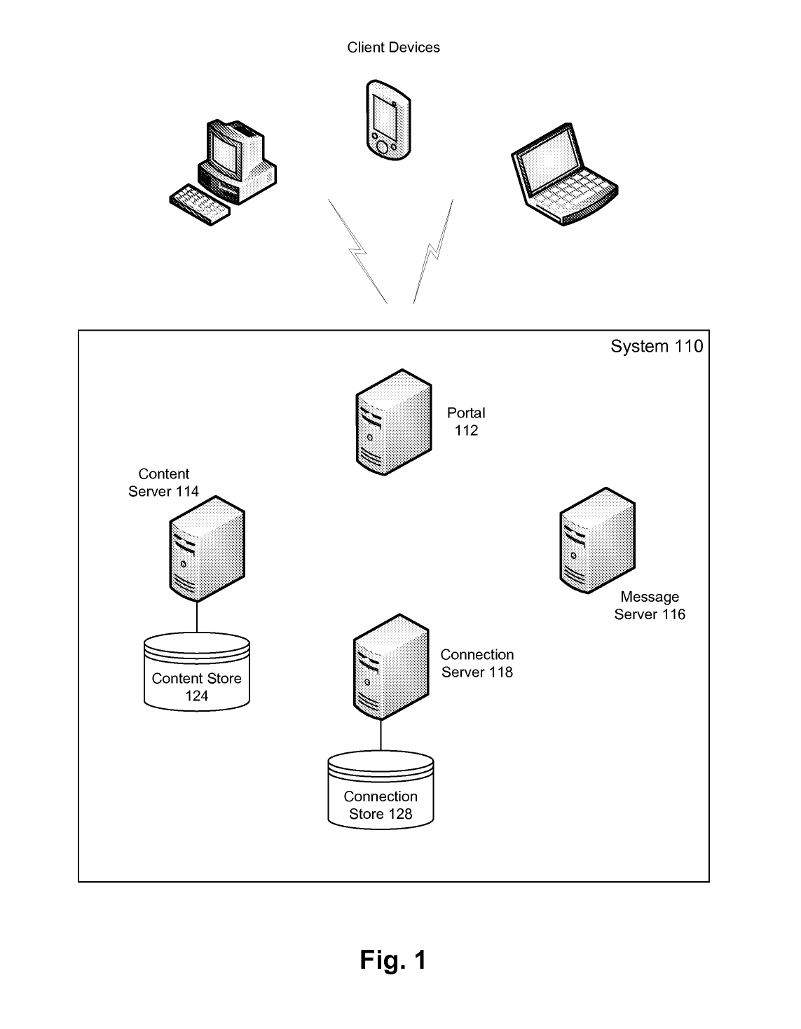

FIG. 1 is a block diagram of a system for supporting simultaneous creation of multiple user associations or connections, according to some embodiments.

System 110 of FIG. 1 is (or is part of) a system that hosts a professional or social networking service or system that helps members create, develop, and maintain professional (and personal) relationships, as provided by LinkedIn® Corporation for example. In other embodiments, however, a system that supports simultaneous creation of multiple user connections may be separate from the application or service that features the user connections, and the application or service may involve activity other than professional or social networking.

Members or users of a service hosted by system 110 connect to the system via client devices, which may be stationary (e.g., desktop computer, workstation) or mobile (e.g., smartphone, tablet computer, laptop computer). The client devices operate suitable client applications, such as a browser program or an application designed specifically to access a service offered by system 110.

As part of the service(s) it offers, system 110 serves content for presentation to users via their client devices. The content that is served may include status updates, messages, advertisements, offers, announcements, job listings, news, and so on, and may be or may include any type of media (e.g., text, images, video, audio). System 110 may serve content generated by users of the system's services, and/or content supplied by third parties for delivery to users of those services.

Users of system 110 may be termed members because they may be required to register with the system in order to fully access the available services. Members may be identified and differentiated by username, electronic mail address, telephone number, and/or some other unique identifier.

Interactive user sessions are generally made through portal 112, which may comprise an application server, a web server, and/or some other gateway or entry point. The portal through which a given user session is established may depend on the user's device or method of connection. System 110 also includes content server 114, message server 116, connection server 118, content store 124, and connection store 128.

Content server 114 maintains one or more repositories of content items for serving to members (e.g., content store 124), an index of the content items, and/or other information useful in serving content to members. Illustratively, content server 114 may serve on the order of hundreds of millions of content items every day, for each of which the system may store an event record (in addition to data reflecting other user activity). For example, a separate server (not depicted in FIG. 1) may track users' activities within the system, interactions with content delivered to them, and so on.

As indicated above, content store 124 may include various types of content and content items, including status updates, information released by members and possibly non-members (e.g., announcements, messages), documents, advertisements (e.g., revenue and/or non-revenue ads), job listings, media (e.g., images, video, audio), and so on, for serving to members and/or for use by various components of system 110. Content server 114 (or some other component of system 110) may include a recommendation module for recommending content to serve to a member.

Message server 116 exchanges communications with users of the system and possibly other entities. In particular, the message server receives, processes, and dispatches communications on behalf of system 110 and/or members of a service hosted by the system. In some implementations, different message servers may be implemented to handle different types of messages (e.g., electronic mail, SMS (or Short Message Service) messages, chat); in other implementations, a single message server may handle multiple types of messages.

Depending on the type of message processed by message server 116, a given member or user may be identified by electronic mail address, telephone number, username, hash tag, or some other identifier. System 110 may store any number of aliases for a given member, to correlate that member's various identifiers as used for different types of messages or different messaging applications. Thus, message server 116 or some other component of system 110 can readily determine whether a given identifier belongs to an existing member of the system's service(s), and can retrieve information regarding that member (e.g., to determine his or her reputation, to identify the member by name, to retrieve the member's existing member connections and/or group memberships).

Connection server 118 stores data representing members' associations/connections. Illustratively, the members' associations may be stored as a graph in which each node corresponds to one member or user, and each edge between two nodes corresponds to a relationship between the members/users represented by the two nodes. The network of members of a service offered by system 110 may number in the tens or hundreds of millions, and so the graph of members' associations may be distributed across multiple databases or repositories, instead of the single connection store 128 depicted in FIG. 1.

Members of a service hosted by system 110 have corresponding pages (e.g., web pages, content pages) on the system, which they may use to facilitate their activities with the system and with each other. These pages (or information provided to members via these pages) are available to some or all other members to visit in order to browse messages, announcements, and/or other information provided by or associated with the corresponding member. Members' pages may be stored on a component of system 110 depicted in FIG. 1, or on a component not shown in the figure.

Members may have different degrees of access to different content. Some members may post or publish information accessible to all members, while some other members may only allow their information to be accessed by users with whom they have formed associations or connections. An association formed between two members within system 110 may reflect a professional or social connection they share, may reflect a common attribute or experience (e.g., graduation from the same university, attendance at the same seminar, participation in the same social event), or may indicate that one member is interested in what the other publishes.

Typically, an association or connection between two members is formed within the system after a first member initiates a connection or association request to the second member, and the second member responds positively. System 110 may provide a control that the first member can activate to initiate the request. For example, the first member may search for the second member by name and, as part of the search results, the system may offer a control that the first member activates and that causes the request to be dispatched to the second member.

As another example, the first member may encounter a content item (e.g., an article, a post, a status update, a comment) that was authored by the second member or that mentions the second member, and which provides a control for initiating a connection request. In some situations, therefore, the system offers or suggests a connection opportunity to a member, and the member may or may take advantage of the opportunity to initiate a connection request.

However, system 110 also supports the simultaneous formation of multiple member associations, wherein some or all of the members are proactively selected or identified by a member, without being prompted by the system. For example, one member may submit a message (e.g., an electronic mail message, a text message, a service request) to system 110 (e.g., message server 116) that identifies multiple members, or may fill out an online form or use some other interactive interface to identify the members. The system then invites each of them to approve connections with each other, and forms appropriate associations as they respond to the invitations.

System 110 may include other components not illustrated in FIG. 1. For example, in some embodiments system 110 may include a profile server to maintain profiles, in a profile database, of members of the service(s) hosted by system 110.

An individual member's profile may reflect any number of attributes or characteristics of the member, including personal (e.g., gender, age or age range, interests, hobbies, member ID), professional (e.g., employment status, job title, functional area or industry, employer, skills, endorsements, professional awards), social (e.g., organizations the user is a member of, geographic area of residence, friends), educational (e.g., degree(s), university attended, other training), etc. A member's profile, or attributes or dimensions of a member's profile, may be used in various ways by system components (e.g., to identify who sent a message, to identify a recipient of a status update, to record a content-delivery event).

Organizations may also be members of the service (i.e., in addition to individuals), and may have associated descriptions or profiles comprising attributes such as industry (e.g., information technology, manufacturing, finance), size, location, goal, etc. An “organization” may be a company, a corporation, a partnership, a firm, a government agency or entity, a not-for-profit entity, an online community (e.g., a user group), or some other entity formed for virtually any purpose (e.g., professional, social, educational).

A profile server may be combined with a connection server, in which case the combined server maintains members' profiles and also stores members' associations with each other. Alternatively, a connection server may be distinct from a profile server, but there may be overlap between the information stored on the connection server and on the profile servers.

The functionality of system 110 may be distributed among the illustrated components in an alternative manner, such as by merging or further dividing functions of one or more components, or may be distributed among a different collection of components. Yet further, while depicted as separate and individual hardware components (e.g., computer servers) in FIG. 1, one or more of portal 112, content server 114, message server 116, and connection server 118 may alternatively be implemented as separate software modules executing on one or more computer servers. Thus, although only a single instance of a particular component of system 110 may be illustrated in FIG. 1, it should be understood that multiple instances of some or all components may be utilized.

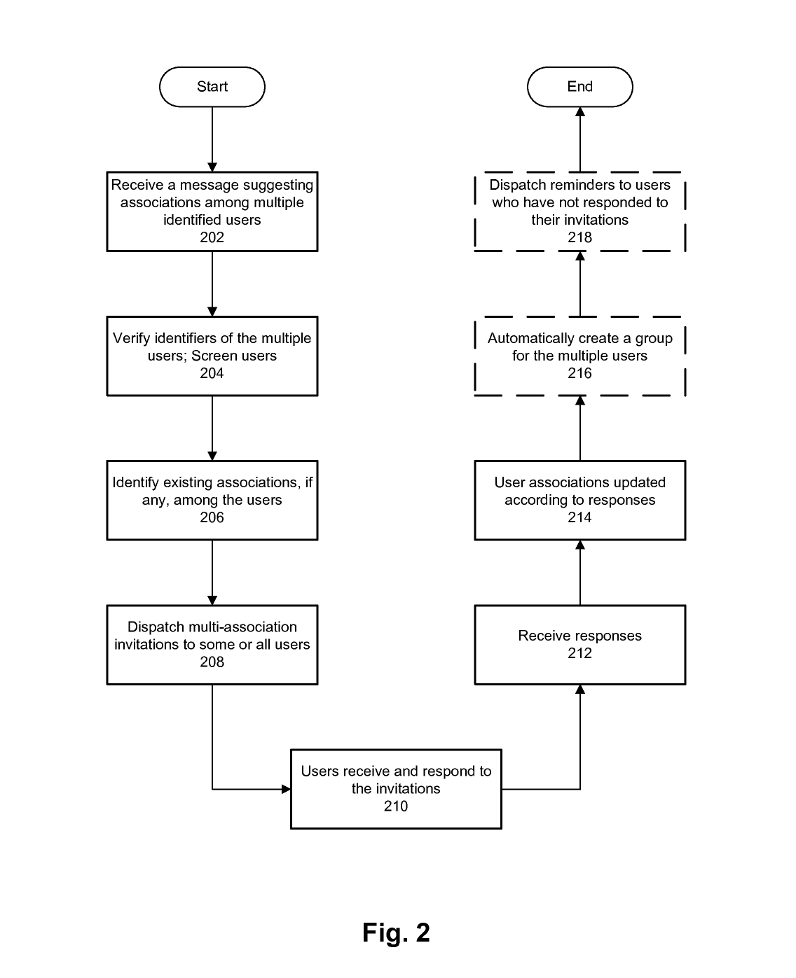

FIG. 2 is a flow chart demonstrating a method of simultaneously forming or facilitating connections or associations among multiple users of an application or service, according to some embodiments. The illustrated method may be performed by system 110 of FIG. 1, or by a similar combination of computing and communication resources.

In operation 202, a system that hosts an application or service, or that is able to manage connections between users of an application or service, receives a message that requests or suggests formation of associations/connections among multiple identified users.

In an illustrative implementation, the message is an electronic mail message addressed to a specific account, such as allin@linkedin.com, and identifies the multiple users—as addressees of the message (in the “to,” “cc,” or “bcc” field), by listing them in the body of the message, or in some other way. They may therefore be identified by full or partial name, by electronic mail address, by a username associated with the application or service, or with some other type of identifier.

In another illustrative implementation, the message is a text message or a chat message received at a specific telephone number or account, and may identify the users by telephone number or username. In yet another illustrative implementation, the message is initiated by a user while he or she is engaged with a personal page, home page, or other interface provided by the application or service.

The message may be sent by one of the multiple users, or by someone else. For example, a teacher, counselor, or other person with authority over a group of students, participants, or other people involved in a common experience may initiate the process on behalf of those people. The message may be received and processed by an electronic mail server, a chat server, or some other communication server (e.g., message server 116 of FIG. 1).

In operation 204, some or all of the users' identifiers are verified. For example, the identifiers may be compared with identifiers of known (e.g., registered) users of the application or service. If any of the identifiers do not correspond to known users, in addition to other action described herein, the corresponding users may be invited to register with, or create an account with, the application or service. Alternatively, the illustrated procedure may only be applied for users currently known to the application or service.

Also in operation 204, the users may be screened to eliminate any undesirable actors, such as users who have been denied access to the application or service, users who have bad reputations (e.g., for sending spam, for offensive behavior, for posting objectionable content), or users who should be denied use of the simultaneous user associations feature for some other reason.

Verifying and screening the users may be performed by a server specially configured for these purposes, by a server that maintains users' associations (e.g., connection server 118 of FIG. 1), or some other entity.

In operation 206, existing associations among the identified users are detected, if any. This allows the system to tailor each user's invitation, as described below. In some embodiments, this operation is optional.

In operation 208, the system dispatches invitations to some or all of the multiple users (e.g., all of the multiple users who are not currently associated with or connected to all other users), inviting them to accept associations or connections with any or all of the other users. In the illustrated method, each user receives a personalized message, or is provided a personalized interface, that allows him or her to individually accept or reject association with each other user in the multiple users. For ease of operation, the user may also be provided with options to accept or reject all offered connections, to add someone to the multiple users, to identify someone who should be removed (e.g., because he or she did not share in the same event or experience as the other users).

In some implementations, a given user's personalized invitation will omit any reference to users with whom the given user is already connected. In some other implementations, such users will still be identified, but the existence of a connection will be indicated (and the given user may or may not be able to sever the connection).

Also, in some implementations, a given user's invitation will indicate which of the other users, if any, have already approved associations with that user. In these implementations, the user's invitation includes a link to an online interface that is dynamically updated as users respond to their invitations, or when the invitation is opened, it may dynamically retrieve a current status of the multi-user associations, or at least the associations that involve the given user. Because some users will act on their invitations before others, by the time the given user chooses to (or is able to) attend to the invitation, some other users may have already approved connections with the user, and this information may be provided to him or her.

The user may be able to re-visit a site or page dedicated to the multiple users' associations (e.g., by navigating to a URL provided in the invitation message), as desired, to see current statuses of his or her associations with other users, and possible associations between other users. For example, the site or page may display a graph depicting the multiple users' approved connections. Each user could be represented by a node, and one-way links between nodes may denote associations approved by one of the two users connected by the link, while two-way links denote approval by both users. Different types of links (e.g., one-way, two-way) may be indicated with different colors, thicknesses, terminations (e.g., arrows, no arrows), and/or other characteristics.

In operation 210, the users respond to their invitations.

In operation 212, the responses are returned to the system (e.g., to a message server). Depending on how the invitations are formatted (e.g., as electronic mail messages, as chat messages, as web pages opened by activating links sent via electronic mail or chat), as forms filled in while using the application or service, the responses may be received at a message server, a web server, a connection server, or some other entity.

In operation 214, the users' responses are applied to update a graph or other collection of user associations. In the illustrated method, creation of a given association (e.g., link) between two users (e.g., nodes) requires both of the users to indicate their assent. Thus, a given user's response to a multi-association invitation, in which he or she approves an association with one or more other users, may be retained for some period of time until the other users respond.

In optional operation 216, a new user group may be created to include some or all of the multiple users, to help them engage in chat sessions, to facilitate sharing of content among the multiple users, and/or for some other reason. Illustratively, the message received in operation 202 may request creation of a group, or the invitations sent in operation 208 may solicit interest in joining such a group. All users may be added automatically to the new group (unless they request not to join it), or users may be added one at a time as they respond to the invitations.

In some implementations, a page or interface provided by the application or service to allow the multiple users to view statuses of the multi-user associations as discussed above, may be or become the home page of the new user group created for the users. Thus, in addition to displaying or indicating associations among the multiple users, it may also provide for chat, discussion, a forum, content sharing, updates regarding the group and/or a shared experience or something the users have in common, etc.

In optional operation 218, reminders may be sent to users who have not responded to their invitations. A reminder or an original invitation sent to a given user may indicate that another user has already approved or accepted an association with the given user, but this is not required. After operation 218, the method ends.

If a second user submits a message suggesting associations among a similar (or identical) set of users to that identified in an earlier request, the system may update the method of FIG. 2 even while it is being conducted in response to the earlier request. Illustratively, when a message or interactive request is received at the designated account, and recognized as a request or suggestion to facilitate associations among multiple members, the request is compared with other requests—such as all active or pending requests that have not been fully resolved, or all requests received within some time period (e.g., the last week, the last month).

If the new request is identical to a previous request (i.e., it identifies the same set of users), or identifies a subset of the users identified in a previous request, it may be cancelled or ignored, and/or or may cause reminders to be sent to any identified users who have not responded to invitations sent in response to the previous request.

If the new request identifies all users identified in a (recent) previous request, plus one or more additional users, the system may add the additional users to the set of users identified in the previous request, and send updated invitations to the previously identified users and new invitations to the new users. In some implementations, however, the number of new or additional users cannot be more than a threshold (e.g., 5, 10, 25) or more than a predetermined percentage of the number of users previously identified (e.g., 10%, 20%).

In some embodiments, after a request or suggestion regarding simultaneous formation of multiple associations is received, a link or other control may be provided to the originator of the request or suggestion. The originator may activate the control to access an interface that he or she can use to amend the request to add or remove one or more people, correct the spelling of a name, correct an identifier, provide a new identifier for a previously identified person, provide a suggested name for a group, and/or take other action. The control may expire after some period of time (e.g., 24 hours after the original request, 48 hours after the last correction or change).

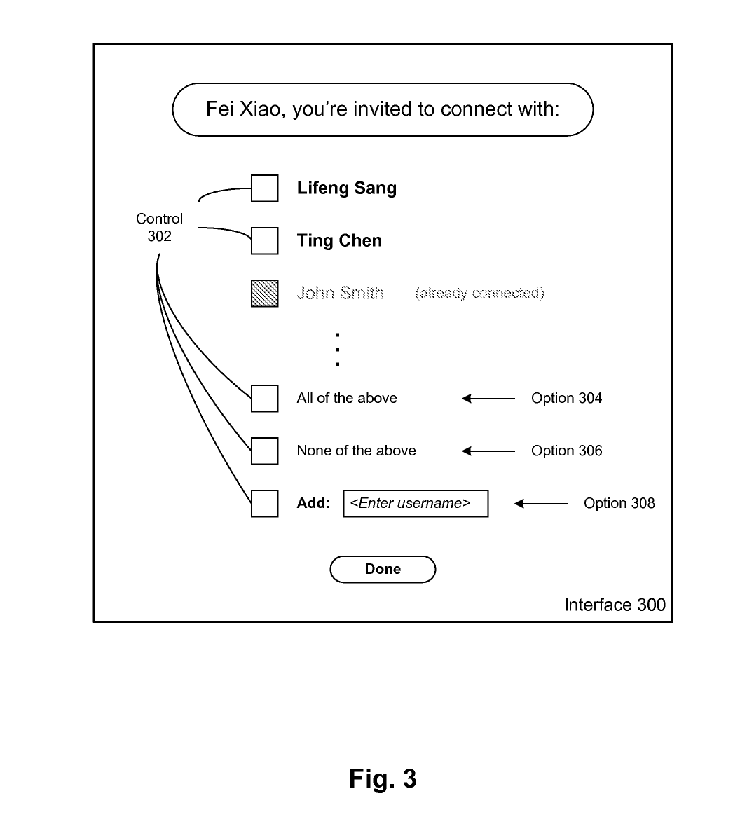

FIG. 3 is an illustrative invitation sent to one of multiple users identified for simultaneous formation of associations, according to some embodiments. In these embodiments, interface 300 may be a web page, a portion of a page of content (e.g., a frame) within an application or service, a form, or some other mechanism that is delivered to a user or that is opened for the user when he or she activates a control (e.g., a hyperlink) sent to him via electronic mail, text message, or other type of communication.

In some implementations, the interface or the communication that contains or that links to the interface may identify who initiated the multi-user association, may identify the reason for the multi-association suggestion, and/or provide other information. For example, the request that caused the invitation of FIG. 3 to be dispatched may identify the event or experience that the multiple users shared, or may provide an explanation of why the requester thinks the users should form connections, and this information may be provided within interface 300.

Interface 300 offers the receiving user radio buttons or other controls 302 for selecting any or all of the multiple users other than himself. In the illustrated example, the user is already connected to John Smith; therefore, the corresponding option is grayed out. He is also offered options to quickly select all other users (option 304) or none of the other users (option 306).

In some implementations, the user is offered option 308 to add another user to the multiple users. For example, if the user notices that someone was inadvertently omitted from the list of people who participated in a shared experience (e.g., a class, an orientation, a trip), he may enter the missing user's name, username, telephone number, or other identifier, activate the corresponding control 302, and request the missing user be included. Depending on the reputation or trustworthiness of the user who receives and responds to interface 300, the missing user may be immediately added, may be ignored, or may be added only after one or more additional users request he or she be added.

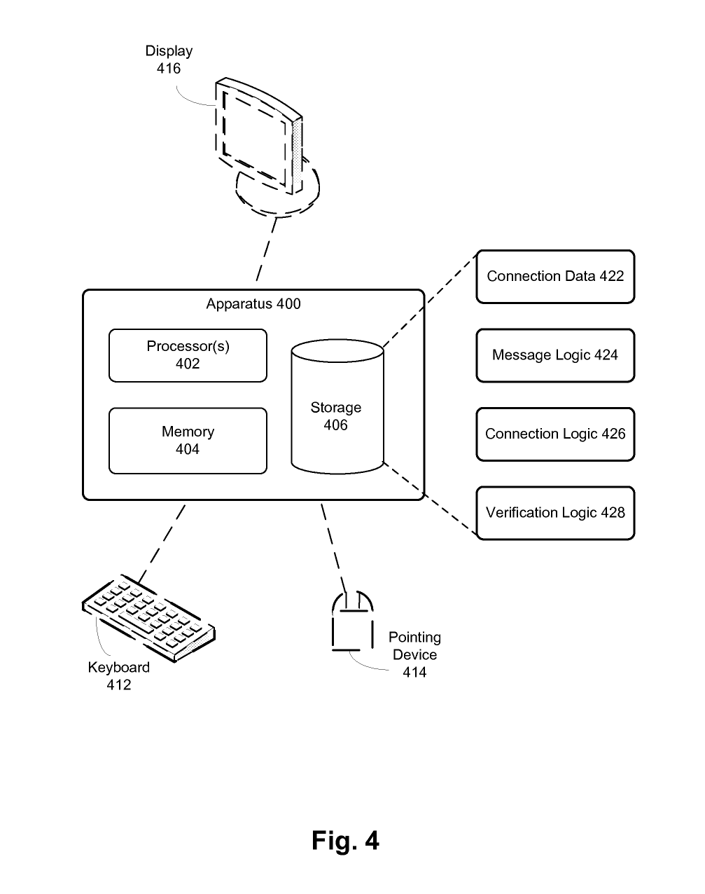

FIG. 4 is a block diagram of an apparatus for simultaneously forming connections or associations among multiple users of an application or service, according to some embodiments.

Apparatus 400 of FIG. 4 comprises processor(s) 402, memory 404, and storage 406, which may comprise one or more optical, solid-state, and/or magnetic storage components. Storage 406 may be local or remote to the apparatus. Apparatus 400 may be coupled (permanently or temporarily) to keyboard 412, pointing device 414, and display 416. Multiple apparatuses 400 may cooperatively operate to process multi-user association requests and suggestions, or apparatus 400 may encompass multiple separate logical and/or physical components that operate similarly.

Storage 406 stores connection data 422 comprising some or all of a graph of user connections/associations, wherein each node represents a user or member of a professional or social network (or other online application or service), and each edge represents an association or connection between two users. Connection data 422 may optionally also include one or more attributes of each user. For example, if the node represents a member of a professional or social network, the attributes may include any number of personal, professional, social, and/or educational attributes of the member.

Storage 406 also stores logic that may be loaded into memory 404 for execution by processor(s) 402. Such logic includes message logic 424, connection logic 426, and verification logic 428. In other embodiments, these logic modules and/or other content may be combined or divided to aggregate or separate their functionality as desired.

Message logic 424 comprises processor-executable instructions for receiving, processing, and sending messages of one or more types (e.g., electronic mail, text or SMS, chat), which may include text, audio, video, and/or multi-media. In particular, message logic 424 is executed to receive requests for simultaneous formation of associations among multiple users, send invitations to the identified users, and receive their responses.

Connection logic 426 comprises processor-executable instructions for manipulating and maintaining connection data 422. For example, connection logic 426 may be executed to search the connection data for existing connections or associations among multiple users identified in a request for simultaneous formation of associations, and may also be executed to update the connection data when the users respond to their multi-association or multi-connection invitations.

Verification logic 428 comprises processor-executable instructions for verifying users' identities or identifiers (e.g., usernames, electronic mail addresses, telephone numbers) and/or for screening out unreliable or undesirable users—such as users known to spam other users, publish offensive content, have poor reputations, or otherwise misuse the application or service.

In some embodiments, apparatus 400 performs some or all of the functions ascribed to message server 116, connection server 118, and connection store 128 of FIG. 1. Apparatus 400 may include other components, or function cooperatively with other components, to host the application or service and/or for other purposes.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory, non-volatile memory, magnetic and optical storage devices such as disk drives, magnetic tape, CDs (compact discs) and DVDs (digital versatile discs or digital video discs), solid-state drives and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method of facilitating simultaneous formation of connections among multiple users of an online service, the method comprising:
receiving a message requesting formation of the connections, wherein the message includes identifiers of the multiple users; and
for each user in the multiple users:
transmitting to the user an invitation to form connections with each of the other users in the multiple users; and
forming connections between the user and each of the other users who accept the invitation to connect with the user.

2. The method of claim 1, further comprising, for each user in the multiple users:
identifying other users in the multiple users with whom the user is already connected, if any; and
omitting from the invitation connections between the user and the identified other users, if any.

3. The method of claim 1, further comprising:
receiving a second message requesting formation of the connections, wherein the second message includes identifiers of one or more additional users not identified in the message; and
for each user in the multiple users, transmitting to the user an updated invitation to form connections with the one or more additional users.

4. The method of claim 1, further comprising:
in a first invitation to a first user in the multiple users, soliciting identities of additional users to be included in the multiple users;
receiving a response to the first invitation, wherein the response identifies one or more additional users not identified in the message; and
for one or more users in the multiple users, transmitting to the user an updated invitation to form connections with the one or more additional users.

5. The method of claim 1, wherein the message is received from one of the multiple users.

6. The method of claim 1, wherein the message is received from a user not included in the multiple users.

7. The method of claim 1, further comprising:
identifying reputations of the multiple users within the online service; and
based on the reputations, omitting at least one of the multiple users from the invitations.

8. The method of claim 1, further comprising:
identifying an originator of the message; and
if the originator is blacklisted by the online service, ignoring the message by not sending the invitations.

9. The method of claim 1, further comprising:
comparing the identifiers to identifiers of users received within one or more previous messages.

10. A system for facilitating simultaneous formation of connections among multiple users of an online service, comprising:
a message server operated to:
receive a message requesting formation of the connections, wherein the message includes identifiers of the multiple users; and
for each user in the multiple users, transmit to the user an invitation to form connections with each of the other users in the multiple users; and
a connection server operated to:
for each user in the multiple users, form connections between the user and each of the other users who accept the invitation to connect with the user.

11. The system of claim 10, wherein the connection server is further operated to:
for each user in the multiple users, identify other users in the multiple users with whom the user is already connected, if any; and
cause connections between the user and the identified other users, if any, to be omitted from the invitation transmitted to the user.

12. The system of claim 10, wherein the message server is further operated to:
receive a second message requesting formation of the connections, wherein the second message includes identifiers of one or more additional users not identified in the message; and
for each user in the multiple users, transmitting to the user an updated invitation to form connections with the one or more additional users.

13. The system of claim 10, wherein the message server is further operated to:
in a first invitation to a first user in the multiple users, solicit identities of additional users to be included in the multiple users;
receive a response to the first invitation, wherein the response identifies one or more additional users not identified in the message; and
for one or more users in the multiple users, transmit to the user an updated invitation to form connections with the one or more additional users.

14. The system of claim 10, wherein the message server is further operated to:
identify reputations of the multiple users within the online service; and
based on the reputations, omit at least one of the multiple users from the invitations.

15. An apparatus for facilitating simultaneous formation of connections among multiple users of an online service, the apparatus comprising:
one or more processors; and
memory storing instructions that, when executed by the one or more processors, cause the apparatus to:
receive a message requesting formation of the connections, wherein the message includes identifiers of the multiple users; and
for each user in the multiple users:
transmit to the user an invitation to form connections with each of the other users in the multiple users; and
form connections between the user and each of the other users who accept the invitation to connect with the user.

16. The apparatus of claim 15, further comprising:
a repository of connection data identifying connections between users of the online service.

17. The apparatus of claim 15, wherein the memory further stores instructions that, when executed by the one or more processors, cause the apparatus to, for each user in the multiple users:
identify other users in the multiple users with whom the user is already connected, if any; and
omitting from the invitation connections between the user and the identified other users, if any.

18. The apparatus of claim 15, wherein the memory further stores instructions that, when executed by the one or more processors, cause the apparatus to:
receive a second message requesting formation of the connections, wherein the second message includes identifiers of one or more additional users not identified in the message; and
for each user in the multiple users, transmit to the user an updated invitation to form connections with the one or more additional users.

19. The apparatus of claim 15, wherein the memory further stores instructions that, when executed by the one or more processors, cause the apparatus to:
in a first invitation to a first user in the multiple users, solicit identities of additional users to be included in the multiple users;
receive a response to the first invitation, wherein the response identifies one or more additional users not identified in the message; and
for one or more users in the multiple users, transmit to the user an updated invitation to form connections with the one or more additional users.

20. The apparatus of claim 15, wherein the memory further stores instructions that, when executed by the one or more processors, cause the apparatus to:
identify reputations of the multiple users within the online service; and
based on the reputations, omit at least one of the multiple users from the invitations.
